(19) United States
(12) Patent Application Publication
(10) Pub. No.: US 2016/0138301 A1
(43) Pub. Date: May 19, 2016

(54) SELF-CONTAINED ELECTRONIC STOWAGE BIN SYSTEM

(71) Applicant: The Boeing Company, Chicago, IL (US)

(72) Inventors: Chad D. Schmitz, Arlington, WA (US); Aaron J. Pederson, Seattle, WA (US); Mark L. Cloud, Seattle, WA (US)

(21) Appl. No.: 14/542,265

(22) Filed: Nov. 14, 2014

(51) Int. Cl. E05B 65/52; E05B 47/00; H02N 2/18

(52) U.S. Cl. CPC E05B 65/52; H02N 2/186; E05B 47/0001

(57) ABSTRACT

A self-contained electronic latching system for a stowage bin is disclosed. The system includes an energy storage device, an electronic latch device, a latch button, and one or more energy harvesting systems. The electronic latch device is for opening a door of a stowage bin and is configured to open the door upon receipt of a signal on an input. The electronic latch device is coupled to the energy storage device and is configured to receive electrical power only from the energy storage device. The latch button is for activating an electronic switch coupled to the input of the electronic latch device. The one or more energy harvesting systems are coupled to the energy storage device. Each of the one or more energy harvesting systems is configured to generate electricity and to provide the generated electricity to the energy storage device.

### FIELD

This disclosure relates generally to a self-contained electronic stowage bin system for use in an aircraft.

### BACKGROUND

Traditionally, the contents within overhead stowage bins in an aircraft are secured within such bin by a purely mechanical latch system mounted to the door. This mechanical system includes a handle mechanism connected to latching mechanisms by torque tubes. This requires a number of mechanical elements which add weight, require adjustment, and are subject to wear and limited lifetime.

An electronic stowage bin latch system includes a latch handle coupled to a switch which sends an electronic signal to electronically activated end latches to cause the stowage bin door to open. Traditional electronic stowage bin latch systems are connected to an aircraft's internal power system and cabin management system via long cable runs, adding cost and weight to the aircraft.

Accordingly, there is a need for a stowage bin latching system which is not subject to the problems of the conventional mechanical and electronic stowage bin systems.

### SUMMARY

In one aspect, a self-contained electronic latching system for a stowage bin is disclosed. The system includes an energy storage device, an electronic latch device, a latch button, and one or more energy harvesting systems. The electronic latch device is for opening a door of a stowage bin and is configured to open the door upon receipt of a signal on an input. The electronic latch device is coupled to the energy storage device and is configured to receive electrical power only from the energy storage device. The latch button is for activating an electronic switch coupled to the input of the electronic latch device. The one or more energy harvesting systems are coupled to the energy storage device. Each of the one or more energy harvesting systems is configured to generate electricity and to provide the generated electricity to the energy storage device.

In a further embodiment, the electronic latch device may further comprise an element for securing the door in a closed position. Also, the one or more energy harvesting systems may generate electricity based upon cabin vibrations, based upon motion supplied to a piezoelectric device, or based upon motion supplied to an electromechanical device. Alternatively, the one or more energy harvesting systems may generate electricity using a photovoltaic device and/or using a thermoelectric device.

In a still further embodiment, one of the one or more energy harvesting systems may be incorporated into the latch button and be configured to generate electricity using a piezoelectric device and/or electromechanical device.

The energy storage devices may be either a capacitor or a battery. Further, a low-energy bi-stable display may be mounted on a surface of the latch button which provides an indication of the latching status of the door.

In another aspect, an electronic latching system for a stowage bin is disclosed. The system includes a first energy storage device, an electronic latch device, a latch button, and one or more first energy harvesting systems. The electronic latch device is for opening a door of a stowage bin and is configured to open the door upon receipt of a signal on an input. The electronic latch device is coupled to the first energy storage device and is configured to receive electrical power from the first energy storage device. The latch button is for activating an electronic switch coupled to the input of the electronic latch device. The one or more first energy harvesting systems are coupled to the energy storage device. Each of the one or more first energy harvesting systems is configured to generate electricity and to provide the generated electricity to the energy storage device. Each of the one or more first energy harvesting systems is incorporated into the latch button and is configured to generate electricity based upon piezoelectric and/or electromechanical action.

In a further embodiment, the system includes a second energy storage device and one or more second energy harvesting systems which are coupled to the second energy storage device. Each of the one or more second energy harvesting systems is configured to generate electricity and to provide the generated electricity to the second energy storage device. Each of the one or more second energy harvesting systems is incorporated into the stowage bin. In this further embodiment, the electronic latch device is also coupled to the second energy storage device and is also configured to receive electrical power from the second energy storage device. Each of the one of the one or more second energy harvesting systems may be configured to generate electricity using a piezoelectric device and/or electromechanical device.

In a still further embodiment, the system includes a third energy storage device and one or more third energy harvesting systems coupled to the third energy storage device. Each of the one or more third energy harvesting systems is configured to generate electricity and to provide the generated electricity to the energy storage device. Each of the one or more third energy harvesting systems is mounted outside of the stowage bin. The electronic latch device is also coupled to the third energy storage device and is also configured to receive electrical power from the third energy storage device.

In one alternative further embodiment, the one or more third energy harvesting systems may be configured to generate electricity using piezoelectric device and/or electromechanical device. In another alternative further embodiment, the one or more third energy harvesting systems may be configured to generate electricity using a photovoltaic device and/or a thermoelectric device. In a still further alternative embodiment, the stowage bin may be mounted within an aircraft and at least one of the one or more third energy harvesting systems may be configured to generate electricity by harvesting aircraft cabin vibrations.

In yet another aspect, a method of operating a self-contained electronic latching system for a stowage bin is disclosed. Electricity is generated in one or more energy harvesting systems. The generated electricity is provided to an energy storage device. Upon activation of a latch button, a signal is generated in an electronic switch that is coupled to an input of an electronic latch device. Finally, upon receipt of the signal at the input of the electronic latch device, a door of the stowage bin is caused to open by activating the electronic latch device which is configured to receive electrical power only from the energy storage device.

The features, functions, and advantages that have been discussed can be achieved independently in various embodiments or may be combined in yet other embodiments, further details of which can be seen with reference to the following description and drawings.

### BRIEF DESCRIPTION OF THE DRAWINGS

The following detailed description, given by way of example and not intended to limit the present disclosure solely thereto, will best be understood in conjunction with the accompanying drawings in which:

FIG. 1 is a block diagram of a self-contained electronic stowage bin system according to an aspect of the present disclosure;

FIG. 2 is a block diagram of an alternative embodiment of the a self-contained electronic stowage bin system according to the present disclosure;

FIG. 3 is a diagram of a latch button according to an aspect of the present disclosure;

FIG. 4 is a diagram of a latching mechanism according to an aspect of the present disclosure; and

FIG. 5 is a diagram of an alternative embodiment of a latch button incorporating a bi-stable display for indicating latch status according to a further aspect of the present disclosure.

### DETAILED DESCRIPTION

In the present disclosure, like reference numbers refer to like elements throughout the drawings, which illustrate various exemplary embodiments of the present disclosure.

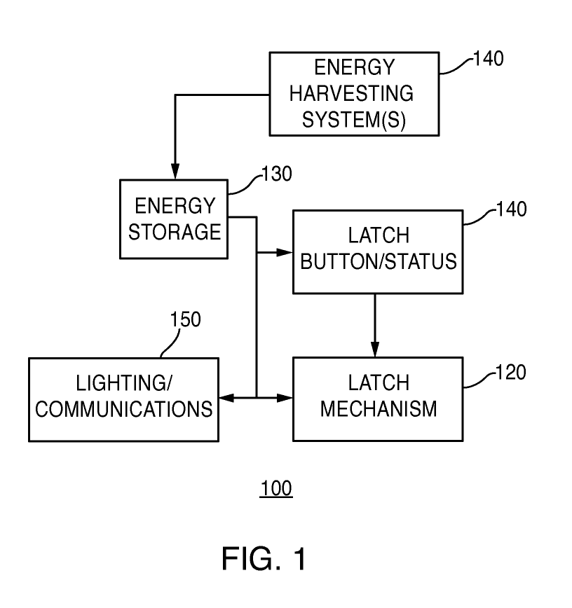

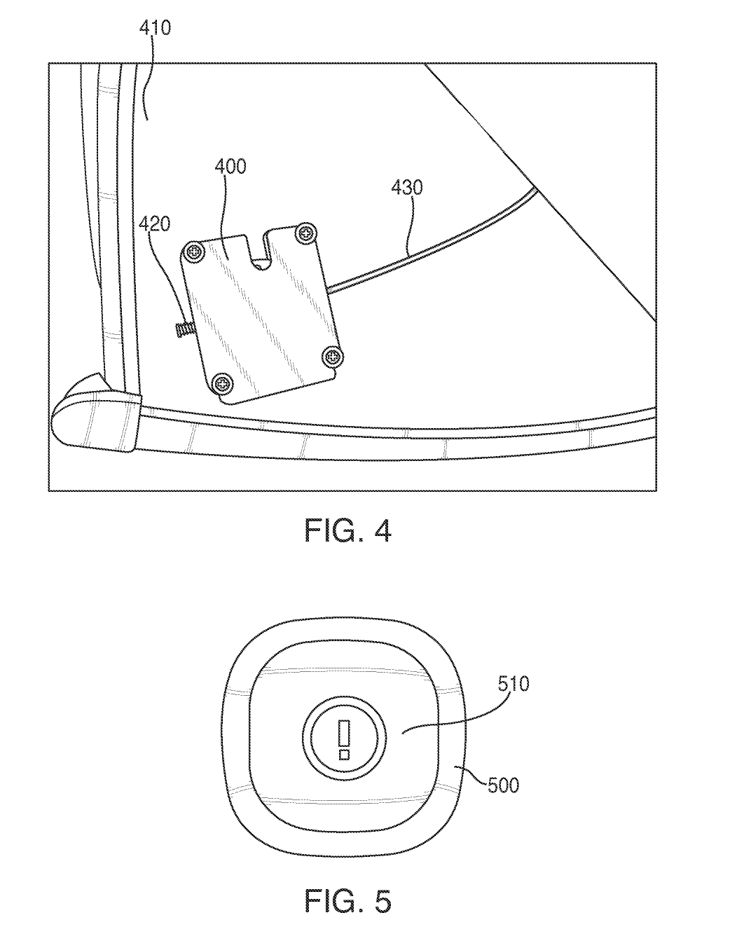

Referring now to FIG. 1, the latching system 100 of the present disclosure includes a latch button 110 (which may also incorporate a status indicator as discussed with respect to FIG. 5 below), an electronic latching mechanism 120, an energy storage device 130, one or more energy harvesting systems 140 and, optionally, lighting and/or communications devices 150. The latch button 110 is an electronic switch mounted, for example, on a door of an aircraft stowage bin that is used to activate the latch mechanism 120. The latch mechanism 120 is shown in detail in FIG. 4 below and consists of, for example, one or more solenoid-driven devices which are used to push open the door of then aircraft stowage bin when activated and which also may incorporate elements used to latch the door when a passenger or airline attendant pushes the door closed. Energy storage device 130 is any conventional device used for the storage of energy, including but not limited to a battery or capacitor and appropriate related electronic circuits. The energy harvesting system (or systems) 140 generate electricity by various methods as discussed below. Finally, lighting and/or communications devices 150 may also be locally powered via energy storage device 130 and may constitute architectural lighting for the local area, indicator lighting as discussed with respect to FIG. 5, and system communications devices (e.g., powered speakers).

Devices used to capture energy may be vibration, piezoelectric, electromechanical (microgenerator), photovoltaic, thermoelectric, or some combination thereof, depending on the type of energy source identified for use. Examples of energy sources include, but are not limited to one or more of the following: (1) rotation of internal latch components; (2) additional linear motion capture of the latch strike interface; (3) rotation at pivot points (e.g., door hinges); (4) linear dampers; (5) motion capture; (6) cabin or external light; (7) thermal gradients; and (8) cabin vibration. In a further embodiment, particularly for new installations, the energy harvesting system 140 may also include a direct connection to the aircraft power system that can provide power to supplement the power generated by the energy capture devices.

In one embodiment, energy storage device 130 may be a rechargeable battery, so that the energy locally generated by energy harvesting systems 140 may be used to continually maintain the energy storage level within such battery. In a further embodiment, the rechargeable battery is replaceable. In another embodiment, energy storage device 130 may be a capacitor (and associated electronic circuitry) that is charged by the energy locally generated by energy harvesting systems 140. In some embodiments, a number of different energy sources are combined to comprise energy harvesting systems 140, as necessary to maintain the required energy level in energy storage device 130 that is necessary to operate latch mechanism 120 and any optionally added ancillary equipment such as lighting/communications devices 150.

In the embodiment shown in FIG. 1, all of the component elements are self-contained and do not require direct connection to the aircraft power. This allows for easy retrofit of existing mechanically latched stowage bins in aircrafts. However, in other embodiments, it may be desirable to add energy harvesting systems which are not proximate to the particular aircraft stowage bin.

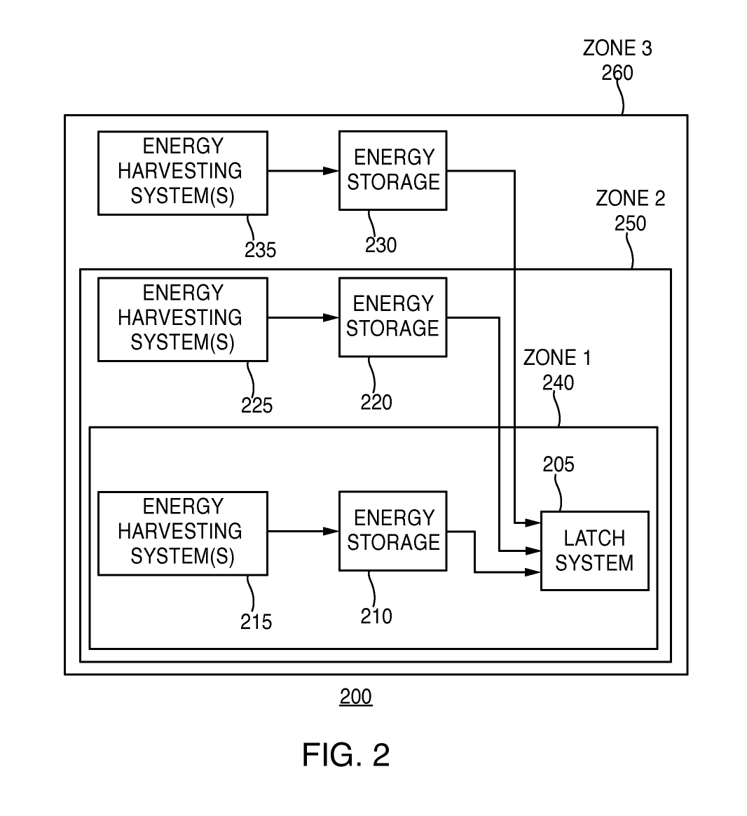

Referring now to FIG. 2, a system 200 is shown which combines both local and remote energy harvesting systems 215, 225, 235. In particular, system 200 includes a latch system 205 (consisting of, for example, latch button 110 and latch mechanism 120 of FIG. 1) coupled to a first energy storage device 210 and a first energy harvesting system (or systems) 215. Latch system 205, first energy storage device 210 and first energy harvesting system (or systems) 215 are located within a first zone 240 (Zone 1) that may be within the confines of the latching system of the aircraft stowage bin. System 200 also include a second energy storage device 220 and an associated second energy harvesting system 225 that is located within a second zone 250 (Zone 2), with second energy storage device 220 also coupled to supply power to latch system 205. Zone 2 250 may consist of the area within the confines of the aircraft stowage bin but separate from the latching system. Finally, system 200 may also include a third energy storage device 230 and an associated second energy harvesting system 235 that is located within a third zone 260 (Zone 3), with third energy storage device 230 also coupled to supply power to latch system 205. Zone 3 350 may consist of the area external to the aircraft stowage bin within the aircraft.

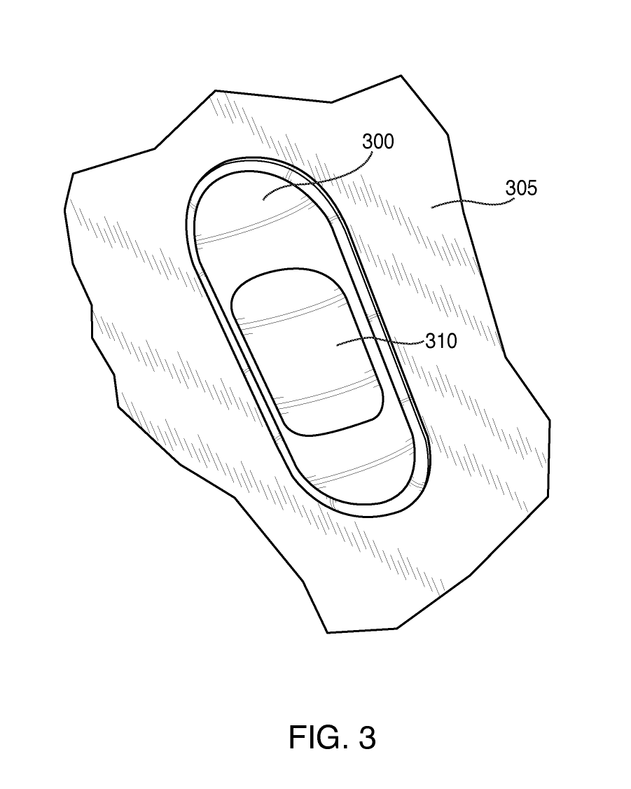

FIG. 3 shows a latch button system 300 mounted in a door 305 of an aircraft stowage bin, including the activation button 310 within the latch button system 300 that includes an electrical switch coupled to the latching mechanism (not shown in FIG. 3). FIG. 4 shows latching mechanism 400 mounted on a sidewall 410 of an open aircraft stowage bin. As discussed above, latching mechanism 400 includes a solenoid-driven member 420 that pushes the door of the aircraft stowage bin open upon activation and may also include latching elements used to keep the door closed when a passenger or airline attendant pushes the door closed. A cable 430 is coupled between the electronic switch in latch button system 300 and latching mechanism 400. When the latch button is activated by a passenger or airline attendant, an electrical signal is passed via electrical conductors in cable 430 from the latch button to latching mechanism 400 to cause latching mechanism 400 to push the door of the aircraft stowage bin open.

Referring now to FIG. 5, an alternative version of the latch button system is shown which incorporates, for example, a conventional low-energy bi-stable display on the face 510 of latch button system 500. This display may be used to indicate when the door of the aircraft stowage bin is not properly secured. The use of a bi-stable display minimizes energy drain, since such a display only requires energy to change states and does not continually consume energy. In FIG. 5, the bi-stable display covers the complete face 510 of latch button system 500, but in other embodiments, such display may cover only a portion thereof. In addition, the use of the character “!” is merely exemplary and, as one of ordinary skill in the art will readily recognize, any desired character or symbol may be used, and, in some cases, the symbol or character may be omitted and the color only may be relied upon to provide an indication that the door of the aircraft stowage bin is not properly secured (i.e., when the color is activated, the door is not closed).

By using a self-contained power generating source, the system disclosed herein combines the best features of mechanical latches (i.e., an independent design) and of electronic latches (i.e., lighter weight and feedback displays). The independent nature of this system allows use in both new aircraft (during construction) and existing aircraft (via retrofit of existing mechanical latch systems).

Although the present disclosure has been particularly shown and described with reference to the preferred embodiments and various aspects thereof, it will be appreciated by those of ordinary skill in the art that various changes and modifications may be made without departing from the spirit and scope of the disclosure. It is intended that the appended claims be interpreted as including the embodiments described herein, the alternatives mentioned above, and all equivalents thereto.

What is claimed is:

1. A self-contained electronic latching system for a stowage bin, comprising:
an energy storage device;
an electronic latch device for opening a door of a stowage bin, the electronic latch device configured to open the door upon receipt of a signal on an input, the electronic latch device coupled to the energy storage device and configured to receive electrical power only from the energy storage device;
a latch button for activating an electronic switch coupled to the input of the electronic latch device; and
one or more energy harvesting systems coupled to the energy storage device, each of the one or more energy harvesting systems configured to generate electricity and to provide the generated electricity to the energy storage device.

2. The self-contained electronic latching system of claim 1, wherein the electronic latch device further comprises an element for securing the door in a closed position.

3. The self-contained electronic latching system of claim 1, wherein one of the one or more energy harvesting systems generates electricity based upon cabin vibrations.

4. The self-contained electronic latching system of claim 1, wherein one of the one or more energy harvesting systems generates electricity based upon motion supplied to a piezoelectric device.

5. The self-contained electronic latching system of claim 1, wherein one of the one or more energy harvesting systems generates electricity based upon motion supplied to an electromechanical device.

6. The self-contained electronic latching system of claim 1, wherein one of the one or more energy harvesting systems generates electricity using a photovoltaic device.

7. The self-contained electronic latching system of claim 1, wherein one of the one or more energy harvesting systems generates electricity using a thermoelectric device.

8. The self-contained electronic latching system of claim 1, wherein one of the one or more energy harvesting systems is incorporated into the latch button and generates electricity using a piezoelectric device and/or electromechanical device.

9. The self-contained electronic latching system of claim 1, wherein the energy storage devices is either a capacitor or a battery.

10. The self-contained electronic latching system of claim 1, further comprising a low-energy bi-stable display mounted on a surface of the latch button, the low-energy bi-stable display providing an indication of the latching status of the door.

11. An electronic latching system for a stowage bin, comprising:
a first energy storage device;
an electronic latch device for opening a door of a stowage bin, the electronic latch device configured to open the door upon receipt of a signal on an input, the electronic latch device coupled to the first energy storage device and configured to receive electrical power from the first energy storage device;
a latch button for activating an electronic switch coupled to the input of the electronic latch device; and
one or more first energy harvesting systems coupled to the energy storage device, each of the one or more first energy harvesting systems configured to generate electricity and to provide the generated electricity to the energy storage device, each of the one or more first energy harvesting systems incorporated into the latch button and configured to generate electricity based upon piezoelectric and/or electromechanical action.

12. The electronic latching system of claim 11, further comprising:
a second energy storage device;
one or more second energy harvesting systems coupled to the second energy storage device, each of the one or more second energy harvesting systems configured to generate electricity and to provide the generated electricity to the second energy storage device, each of the one or more second energy harvesting systems incorporated into the stowage bin; and
wherein the electronic latch device is also coupled to the second energy storage device and is also configured to receive electrical power from the second energy storage device.

13. The electronic latching system of claim 12, wherein one of the one or more second energy harvesting systems is configured to generate electricity using a piezoelectric device and/or electromechanical device.

14. The electronic latching system of claim 12, further comprising:
a third energy storage device;
one or more third energy harvesting systems coupled to the third energy storage device, each of the one or more third energy harvesting systems configured to generate electricity and to provide the generated electricity to the third energy storage device, each of the one or more third energy harvesting systems mounted outside of the stowage bin; and
wherein the electronic latch device is also coupled to the third energy storage device and is also configured to receive electrical power from the third energy storage device.

15. The electronic latching system of claim 14, wherein one of the one or more third energy harvesting systems is configured to generate electricity using piezoelectric device and/or electromechanical device.

16. The electronic latching system of claim 14, wherein one of the one or more third energy harvesting systems is configured to generate electricity using a photovoltaic device.

17. The electronic latching system of claim 14, wherein one of the one or more third energy harvesting systems is configured to generate electricity using a thermoelectric device.

18. The electronic latching system of claim 14, wherein the stowage bin is mounted within an aircraft and wherein one of the one or more third energy harvesting systems is configured to generate electricity by harvesting aircraft cabin vibrations.

19. The self-contained electronic latching system of claim 11, further comprising a low-energy bi-stable display mounted on a surface of the latch button, the low-energy bi-stable display providing an indication of the latching status of the door.

20. A method of operating a self-contained electronic latching system for a stowage bin, comprising the steps of:
generating electricity in one or more energy harvesting systems;
providing the generated electricity to an energy storage device;
upon activation of a latch button, generating a signal in an electronic switch that is coupled to an input of an electronic latch device; and
upon receipt of the signal at the input of the electronic latch device, causing a door of the stowage bin to open by activating the electronic latch device, the electronic latch device configured to receive electrical power only from the energy storage device.
